(19) United States
(12) Patent Application Publication
(10) Pub. No.: US 2008/0204546 A1
(43) Pub. Date: Aug. 28, 2008

(54) Stereoscopic Imaging Device and Means for Construction Thereof

(76) Inventors: Christopher Martin Dawe, Kent (GB); Martin Simon Dawe, London (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/568,198

(22) PCT Filed: Aug. 4, 2004
(86) PCT No.: PCT/GB2004/003369

§ 371 Date: May 15, 2008

(30) Foreign Application Priority Data
Aug. 12, 2003 (GB) 0318892.7

(51) Int. Cl. H04N 13/04

(52) U.S. Cl. 348/51; 348/E13.075

(57) ABSTRACT

A stereoscopic display device comprises a display device for displaying a pixellated display image; and a stereoscopic conversion screen. The conversion screen comprises an array of light guiding members, each light guiding member being associated with an underlying pixel or sub-array of pixels, and wherein alternate rows of light guiding members are arranged to direct light from the associated pixel or sub-array of pixels to different viewing positions. The invention provides spatial multiplexing of images into successive horizontal rows, rather than in vertical columns, as in common practice. This can resolve a looming problem so that a stereoscopic effect is perceived across the full width of the 2D image. This spatial multiplexing screen may be combined with a dynamic temporal multiplexing arrangement to increase the number of views. The invention also relates to such a dynamic temporal multiplexing system. The display device may be switchable between 2D and 3D modes of operation by using electro chromic materials, or by removing the conversion screen.

### FIELD OF THE INVENTION

This invention relates to stereoscopic display devices.

### BACKGROUND OF THE INVENTION

The invention relates to a stereoscopic imaging device of the type that includes a spatially and/or temporally multiplexed screen, hereinafter referred to as a ‘stereoscopic conversion screen’ due to the fact that it converts planar ‘2D-images’ comprised of multiplexed ‘monocular images’ for individual eyes or focal points into a perceived ‘3D-display’. This is placed in front of a spatially or temporally modified 2D-image created by a cathode ray tube, LCD, TFT, projection, plasma or other visual display unit, hereinafter collectively referred to as ‘visual display units’.

In the following description, the following expressions are used for defining where light from the 2D-image is directed. The ‘stereoscopic viewpoint’ is used where two focal points are present, for example the location of an observer's eyes. If a 3D-display can be observed by more than one observer, it can be said to have more than one stereoscopic viewpoint. The term ‘monocular viewpoint’ is used to refer to one focal point, for example the location of one eye. A stereoscopic viewpoint is thus comprised of two monocular viewpoints. The terms ‘horizontal’ and ‘vertical’ are used relative to the orientation of the visual display unit when used normally for viewing a 2D-image or 3D-display.

Spatially multiplexed stereoscopic imaging devices are well-known but suffer from the disadvantage that although the central viewing area provides an acceptable stereoscopic effect, to the left and right of the centre, inversion of the left and right monocular images appear as does a vertical banding effect. The problem is caused at least in part by asymmetric looming due to the difference in viewing positions of the left and right eye.

In the established art, direction of light from the 2D-image to appropriate monocular viewpoints is achieved either by means of a mask that absorbs light that would otherwise reach a monocular viewpoint inappropriately, or by means of a lens array that refracts light in the appropriate directions. As well as banding and inversion effects a masking arrangement suffers from the shortcoming that as a larger number of stereoscopic viewpoints are required, the observed 3D-display becomes dimmer. The lens array approach is difficult to apply in a way that overcomes the aforementioned inversion and banding effects.

### SUMMARY OF THE INVENTION

According to the invention, there is provided a stereoscopic display device, comprising:
a display device for displaying a pixellated display image; and
a stereoscopic conversion screen,
wherein the conversion screen comprises an array of light guiding members, each light guiding member being associated with an underlying pixel or sub-array of pixels, and wherein alternate rows of light guiding members are arranged to direct light from the associated pixel or sub-array of pixels to different viewing positions.

The terms “pixel” and “pixellated” are used to indicate that the output to independent (pixel) areas of the image is controlled independently. This allows portions of different images, in particular different viewpoints, to be displayed at different pixel areas. The term is intended to cover LCD type displays, but also CRT, projection or even photographic display of images.

The invention provides spatial multiplexing of images from successive horizontal rows, rather than vertical columns, as is common practice. This can resolve the looming problem mentioned above, so that a stereoscopic effect is perceived across the full width of the 2D-image and with improved resolution and brightness. The invention uses light guiding members, which may be considered to be ‘light-tubes’, which channel light in the appropriate directions from the monocular image(s) to the monocular viewpoint(s). These may either be hollow or solid transparent material. Preferably, the light guiding members comprise optical light-tubes.

The array of light guiding members may comprise a stack of rows of light guiding members. In particular, different rows are directed in different directions, and these rows may therefore be more easily produced separately. Each row of light guiding members may comprise an arrangement of walls of opaque material defining a plurality of channels which are each directed towards a common view point.

The array of light guiding members may instead comprise a unitary screen formed from opaque material through which holes are formed at predetermined angles. These holes may be punched, or else they may be formed as part of the initial structure of the screen.

The conversion screen provides spatial multiplexing. This spatial multiplexing may be used to give two different image locations, for a single stereoscopic viewpoint. This will be appropriate for a personal computer where a single stereoscopic viewpoint is likely. It may be desirable to provide more stereoscopic viewpoints. However, increasing the number of images multiplexed together reduces resolution and brightness.

In the spatially multiplexed system of the invention, brightness is reduced only slightly in the directions of monocular viewpoints. In the prior art, spatially multiplexed systems using a lens sheet display will appear bright because all of the light from the 2D image is transmitted. However much of the light carries incorrect stereoscopic information. For barrier systems, brightness is reduced in proportion to the number of stereoscopic viewpoints.

To provide more viewing locations, the device can also comprise a temporal multiplexing screen for directing images to different viewing locations in time-multiplexed manner.

Combining or even integrating spatial and temporal conversion screens makes a multiplicative increase in the number of stereoscopic viewpoints possible. Losses in 3D-display resolution are minimised and the need for very high visual display unit refresh rates required by the temporal multiplexing arrangement is decreased. For example, the spatial multiplexing of three sub-images (one into every third row) can be combined with temporal multiplexing with a ratio of 3 (so that three variations of each sub-image are sent to different locations at different times within the field period). This gives nine different images sent to nine different locations within each field period, whilst allowing a spatial multiplexing ratio of only 3 and a temporal multiplexing ratio of 3, which can be effected as an increase of the refresh rate by a factor of three. These 9 different images can give seven stereoscopic viewing locations, because each view can function as a left eye view or a right eye view. Thus, each adjacent pair of views forms a stereoscopic viewing location.

For temporal multiplexing, the screen can comprise an array of movable light guiding members, for example electro statically or electro magnetically controlled. The movable light guiding members can have reflective or absorptive boundaries.

A lenticular screen, comprising an array of lenses each extending in the horizontal direction, can be provided. This acts as a lens diffuser to increase the vertical viewing angle and to improve the visual image appearance to take account of the absence of rows in each sub-image.

According to a second aspect of the invention, there is provided a stereoscopic display device, comprising:
a display device for displaying a pixellated display image; and
a stereoscopic conversion screen,
wherein the conversion screen comprises an array of light guiding members, each light guiding member being associated with an underlying pixel or sub-array of pixels, and wherein the light guiding members are movable to direct the output from the associated underlying pixel or sub-array of pixels to different viewing locations at different times.

This provides the temporally multiplexed screen arrangement. Temporally multiplexed stereoscopic imaging devices are well known, but usually employ a switchable mask such as an LCD mask for the stereoscopic conversion screen. The observed instantaneous 3D-display brightness is then inversely proportional to the number of stereoscopic viewpoints required.

The temporal multiplexing system of the invention reduces brightness only due to the duty cycle. Known temporal multiplexing systems, using a barrier system, instead reduce the brightness both due to the barriers and the duty cycle.

The temporal stereoscopic conversion screen may comprise a multiplicity of electro statically or electro magnetically driven ‘dynamic light-tubes’, which may be of microscopic or molecular dimensions. In this way, light is directed from the 2D-image to any number of stereoscopic viewpoints without a corresponding reduction in instantaneous observed brightness.

The visual display unit (of either aspect of the invention) may comprise raised vertical edge strips that conceal the left and right vertical margins of the image. These avoid loss of stereoscopic vision and enhance the perception of depth at the left and right margins of the 3D-display. These function by minimising loss of parallax at the left and right 3D-display margins.

The stereoscopic conversion screen may be manually removable from the display device. This is useful when the user would rather observe a higher resolution 2D-image than a 3D-display.

The spatially multiplexed screen can be implemented in various ways. For example, possibilities are:
vertically stacked strips containing castellated, corrugated or solid light-tubes, suitably directed to monocular viewpoints;
numerous accurately positioned and directed holes pierced through suitable sheet material that direct light to the appropriate monocular viewpoints;
stacked transparent laminates each with a surface bearing a photographic, photo-etched or printed design, such that when these are stacked, light-tubes with the required directions are constructed. Use of Canada balsam, liquid paraffin, ethylene glycol polymer or other substances of approximately the same refractive index as the laminates can remove any internal reflections between laminates; or
a radiation sensitive sheet of material that darkens or lightens permanently after exposure to particular sources of radiation. A special geometric configuration of the radiation source and sheet can then be used to form light-tubes in the sheet.

The invention also provides an apparatus for forming a stereoscopic conversion screen for a stereoscopic display device, particularly for the design in which holes are pierced through a substrate. The apparatus comprises:
a linear array of hole-piercing members arranged at one end of a piercing shuttle, the other end of the piercing shuttle having a pivot-able mounting, the piercing members being slide-able in a piercing direction with respect to the pivot-able mounting, the piercing direction changing as the shuttle is rotated about the pivot-able mounting;
first and second pivot axes about which the piercing shuttle is mountable to define different convergence points for the holes pierced by the hole piercing members.

This arrangement enables holes to be punched that align with a viewing location, and fixing the shuttle to a different pivot axis can change the viewing location. The hole piercing members may comprise mechanical piercing members or coherent electromagnetic radiation sources or guides.

The invention also provides a method of forming a stereoscopic conversion screen for an stereoscopic display device, comprising:
(i) piercing a linear array of holes using a piercing shuttle into a substrate at a first angle aligned with a parallel rotation axis, the linear array of holes being aligned in a column direction;
(ii) rotating the piercing shuttle about the rotation axis and piercing a further linear array of holes into the substrate at a second angle aligned with the parallel rotation axis;
(iii) repeating steps (i) and (ii) until complete rows of holes have been pierced, each row of holes being aligned with the rotation axis;
(iv) repeating steps (i) to (iii) for a different second rotation axis thereby to provide further complete rows of pierced holes, each further row of holes being aligned with the second rotation axis, alternate rows of holes being aligned with different rotation axes.

The invention also provides a method of generating an stereoscopic image, comprising:
generating a display image in which at least two sub-images are encoded into the complete image, with each sub-image being provided to a plurality of rows of pixels;
displaying the complete image;
using a stereoscopic conversion screen to direct the output of different rows of pixels corresponding to the different sub-images to different viewing positions.

The method may further comprise providing temporal multiplexing to direct images to different viewing locations in time-multiplexed manner.

### BRIEF DESCRIPTION OF THE DRAWINGS

Preferred embodiments of the invention will now be described with reference to the accompanying drawings in which:

FIG. 1 shows an underlying cause of lateral inversion as due to optical looming of the stereoscopic conversion screen in relation to the 2D-image.

FIG. 2 shows the asymmetrical looming that occurs with respect to the left and right eyes.

FIG. 3 shows a vertically stacked structure of strips of castellated light-tubes that allow light to pass in the correct directions to specific monocular viewpoints.

FIG. 4 shows a strip of corrugated light-tubes that may be stacked vertically and which allow light to pass in the correct directions to specific monocular viewpoints.

FIG. 5 shows a strip of light transmitting light-tube elements that may be stacked vertically and which allow light to pass in the correct directions to specific monocular viewpoints.

FIG. 6 shows a ‘multi-hole stereoscopic conversion screen’ with holes acting as light-tubes. All holes in any particular horizontal row direct light to a single monocular viewpoint. All holes in the next row down direct light to another monocular viewpoint. This repeats for as many different monocular viewpoints as are required and then the entire pattern is repeated down the stereoscopic conversion screen.

FIG. 7 shows a full view of a preferred embodiment of the machine for fabrication of a multi-hole stereoscopic conversion screen.

FIG. 8 shows an assembly for the preparation of light-tubes by irradiation of a radiation sensitive sheet.

FIG. 9 shows a detailed view of one form of macroscopic cell for dynamic light-tubes.

FIG. 10 shows the sequence in which a cell of dynamic light-tubes may be electro statically or electromagnetically switched.

FIG. 11 shows a cell of microscopic dynamic light-tubes.

FIG. 12 shows a cell of molecular dynamic light-tubes.

FIG. 13 shows a design that allows a stereoscopic conversion screen to be placed temporarily in front of a visual display unit and removed when required.

FIG. 14 shows the positioning of a sheet containing an array of horizontal lenses for providing a wider vertical viewing angle, multiplying pixels vertically and spreading light over blank horizontal lines.

FIG. 15 shows the positioning of vertical opaque strips placed at the left and right edges of the 3D-display, a small distance in front of the underlying 2D-image.

### DETAILED DESCRIPTION

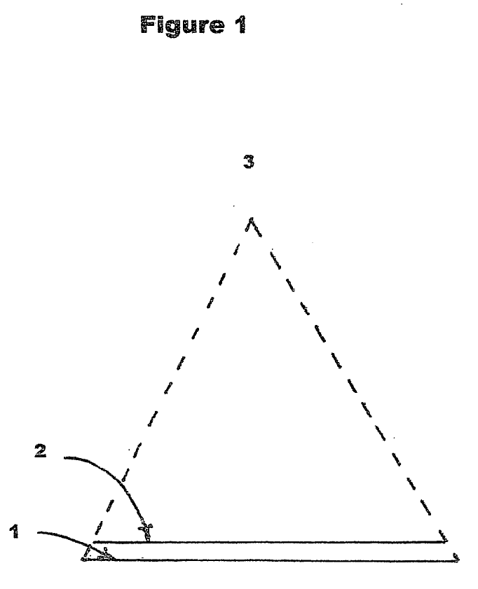

As shown in FIG. 1, from a single viewing point 3, the stereoscopic conversion screen 2 appears to be wider in comparison to the 2D-image 1 than it actually is, an effect known as optical looming. In the established art, because both the 2D-image 1 and stereoscopic conversion screen 2 comprise geometrically vertical strips, there is a loss of phasing between the strips of each. If the width of screen 2 is reduced slightly, as shown, this effect can be removed.

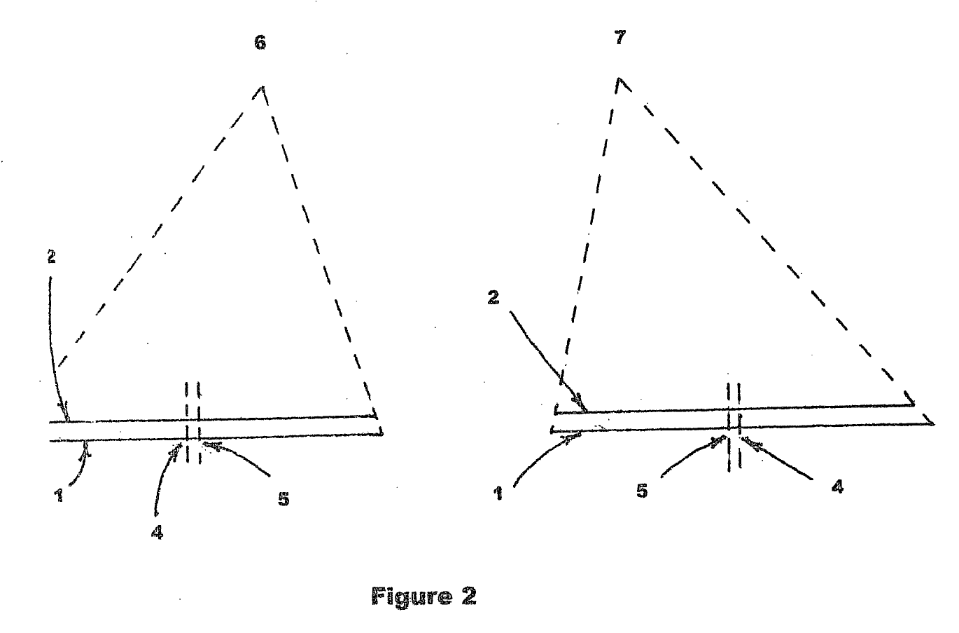

However, as shown in FIG. 2, the different viewing positions of the left eye 6 and right eye 7 give rise to asymmetrical looming. To remove this effect the stereoscopic conversion screen 2 and 2D-image 1 need to be displaced relative to each other since for the two views the 2D-image centre line 5 and stereoscopic conversion screen centre line 4 are not collinear.

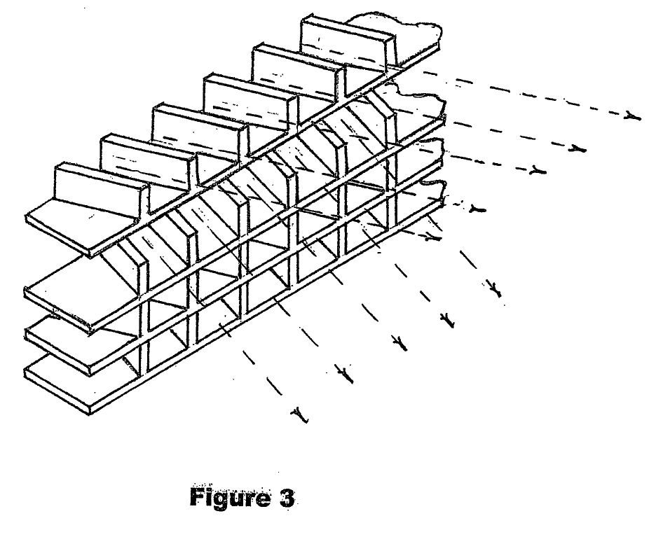

In preferred embodiments of this invention, as shown in FIGS. 3, 4 and 5, light from monocular images may be directed to appropriate monocular viewpoints by the stereoscopic conversion screen 2 using vertically stacked strips of light-tubes. Monocular images for a number of different monocular viewpoints are multiplexed over a number of consecutive horizontal strips. FIGS. 3, 4 and 5 show stacked constructions with three different forms of strip feasible for construction.

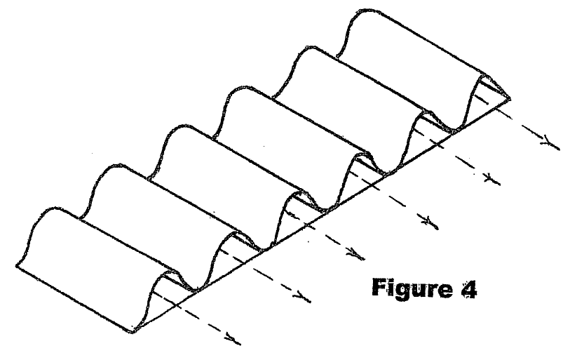

In each case, a row of light guiding members is formed. In FIG. 3, these are walled structures with cavities defining the light path. The walls may be reflective or preferably absorptive. Hard black rubber or polymer-impregnated paper may be compression moulded to produce these. In FIG. 4, light channels are formed using a corrugated structure. These may be made from metal foil or polymer by welding the undulating and flat components together.

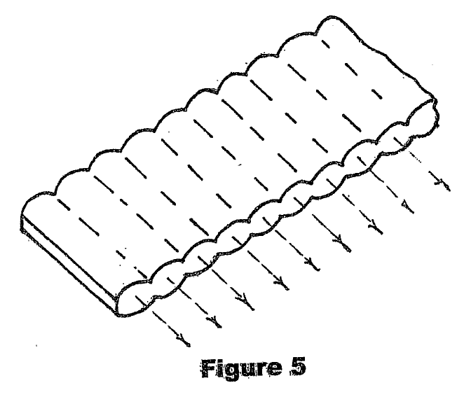

In FIG. 5, optical light guides are used, such as optical fibres. These may for example be of transparent polymer or glass and be coated with a thin layer of a transparent polymer of lower refractive index, in order to achieve total internal reflection. For the structures of FIGS. 3 and 4 it is better that their surfaces be light absorptive, as this will minimise scattering of light. For the structure of FIG. 5, the small optical exit angle due to total internal reflection reduces scattering.

In each case, all of the light guiding members for the row are substantially parallel, although they all converge slightly as they are directed to a common viewing point. The light guiding members for different rows are directed to different monocular viewpoints. There may be only two monocular viewpoints, one for one set of rows and the other for a second set of rows, with the two sets of rows interleaved. There may, however, be more monocular viewpoints, to give more than one stereoscopic viewpoint.

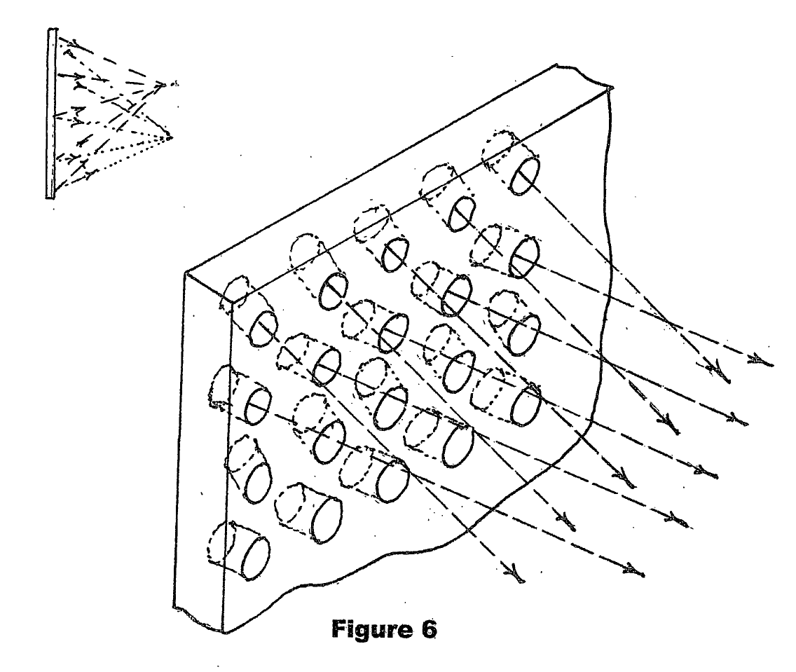

In another preferred embodiment shown in FIG. 6 a multi-hole stereoscopic conversion screen comprises a suitable sheet material, possibly dense black expanded polystyrene, pierced with holes acting as light-tubes that correspond to each picture element or pixel. The direction of these holes is such as to allow light from monocular images to travel only to the appropriate monocular viewpoints (see the insert for FIG. 6, which shows a plan view for two such viewing positions). Intense ultrasound, electromagnetic radiation, particle or fluid bombardment, punching, erosion or piercing may produce such holes. In particular drilling or cutting by laser or a hot fluorocarbon beam would be suitable, dependent on the sheet material. The resolution of the conversion screen need not be limited by the physical size of the source of radiation or particles. A filtering grid of horizontal lines may be placed on or near the sheet during fabrication. A strip source of radiation or particles parallel to the line of the pins previously described can then be employed instead of discrete point sources. Holes might also be produced by nanobotic devices, enzymatic, chemical, microbial or other biological means. In order to add strength to the pierced sheet if necessary, it may be coated or laminated with transparent material before, during or after the hole-making process.

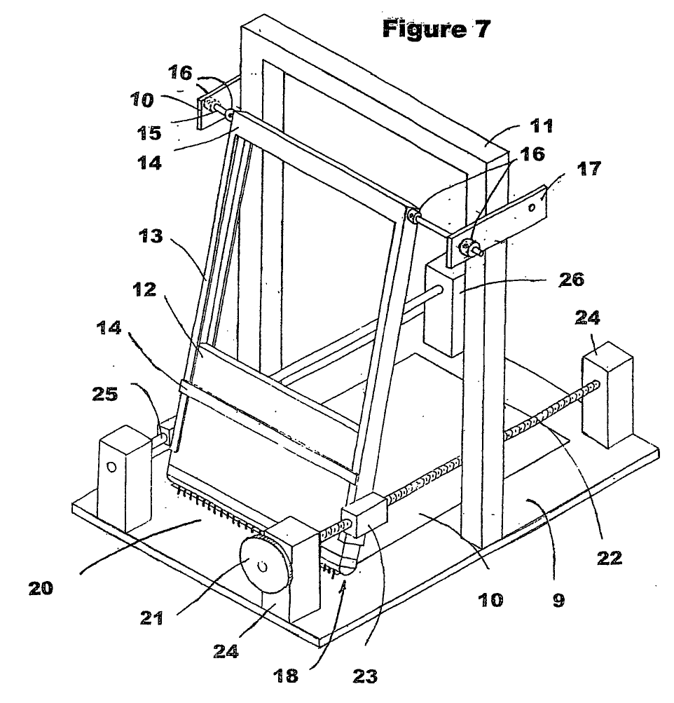

A machine for the fabrication of multi-hole stereoscopic conversion screens is shown in FIG. 7. A robust base plate 9 carrying the material to be pierced 10 and support frame 11 are present to prevent unwanted structural movement of the machine during use. Shuttle 12 is free to move along, channelled guide 13. The channelled guide 13 is re-enforced by tie bars 14. The channelled guide 13 rotates about an axle 15 secured by collars 16. The axle 15 passes through an axle support bar 17 attached to the support frame 11. The lower edge of the shuttle 12 carries a block 18 with bushes (not shown) firmly holding a column of hole-piercing pins 20.

To accurately produce a column of holes of a set inclination, the shuttle 12 is lowered causing the hole piercing pins 20 to pierce the sheet and then raised. To obtain the next column of holes of different inclination the channelled guide 13 is adjusted by rotating control wheel 21. This causes studding 22 to rotate and as it passes through the screwed idling block 23, moves the channelled guide 13, rotating it about the axle 15. The studding 22 has clearance on each of the studding supports 24. For additional stability a guide rod 25 is present, parallel to the studding 22 and fixed to guide rod supports 26.

The pins 20 are all for one viewing location. Thus, in the example where there are two viewing locations, the column of pins is used to form full rows of holes all directed to the first viewing location. The shuttle is then mounted on a second axle position, and the pins are aligned with the intermediate row positions, so that farther complete rows of holes can be formed, interleaved with the previous rows. A system of axles may be in place instead of a single one in order to facilitate change of pivotal position more readily and also to minimise the size of the machine. The machine may employ a fixed channel guide 13 and the base plate orientation and position may be movable to achieve the correct angles and positions for the light-tubes.

If radiation or particle bombardment is used to form light tubes a reflective shield attached to the lower edge of the shuttle 12 may ensure that the light-tubes formed are eccentric. In this way 2D viewing outside of the intended 3D viewing region is obtained.

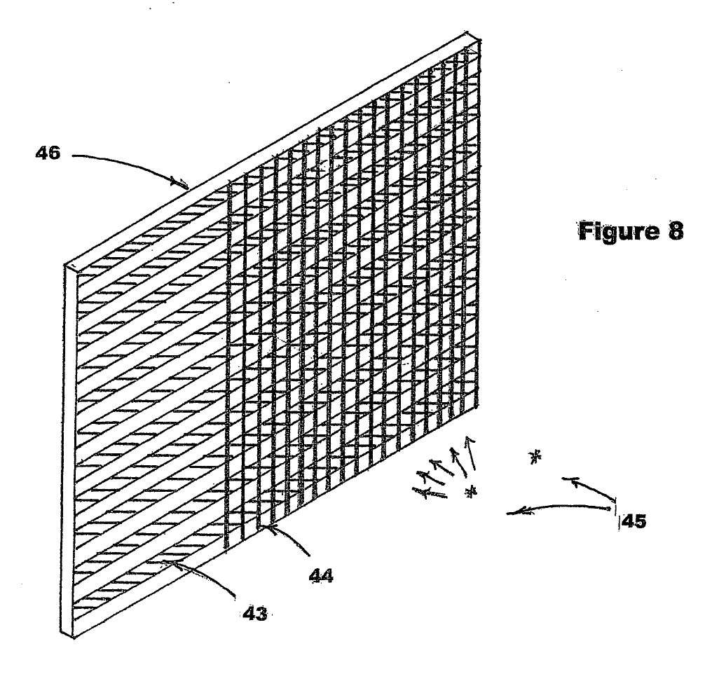

A spatially multiplexed screen manufactured by exposure of a radiation sensitive sheet of material 46, hereinafter referred to as the ‘irradiation sheet’, to radiation sources 45 is shown in FIG. 8. During preparation, areas of the irradiation sheet are selectively masked from the radiation sources by grids 43 and 44 on or near its surface. The directions of the radiation sources 45 correspond to the monocular viewpoints that the stereoscopic. conversion screen is required to direct light to. Vertical masking 44 prevents radiation from reaching particular areas of the irradiation sheet so that light-tubes are formed and in the appropriate directions. These vertical lines may be quite fine, of the order of the inter-pixel spacing.. In this case, the radiation sensitive screen is bleached to transparent upon irradiation to provide light-tube boundaries. Alternatively, the vertical lines may be of the order of a pixel width, a dye then being chosen that will darken upon exposure to irradiation.

The position of horizontal masking 43 is changed between exposures of the irradiation sheet to sources of radiation 45 so that a row of light-tubes for a different monocular viewpoint can be created. The irradiation sheet may be solid or laminated and either change from transparent to opaque or vice versa on exposure to the source of radiation. For example if the radiation is high intensity ultraviolet, a transparent polycarbonate infused with a disperse black dye and an ultraviolet sensitizer such as benzophenone may be used. If ultraviolet radiation is used, it is necessary to protect the finished irradiation sheet by coating or laminating it with a substance that does not allow ambient ultraviolet radiation to reach it in order that the pattern of light-tubes remains permanent. It may be necessary to heat the irradiation sheet during the irradiation to achieve greater permanence at normal viewing temperatures.

The description above relates to the spatially multiplexed stereoscopic conversion screen. To provide more stereoscopic viewpoints, the device can also comprise a separate or integral means for temporal multiplexing, for directing images to different monocular viewpoints in time-multiplexed manner.

By combining the spatial and temporal conversion screens, a multiplicative increase in the number of stereoscopic viewpoints is made possible. Losses in 3D-display resolution are minimised and the need for very high visual display unit refresh rates required by using both spatial and temporal components is decreased.

For example, the spatial multiplexing of three sub-images (one into every third row) can be combined with temporal multiplexing with a ratio of 3 (so that three variations of each sub-image are sent to different locations at different times within the field period). This gives nine different images sent to nine different locations within each field period, whilst requiring a spatial multiplexing ratio of only 3 and a temporal multiplexing ratio of 3, which can be effected as an increase of the refresh rate by a factor of three. Of course, 9 different images can give seven stereoscopic viewing locations.

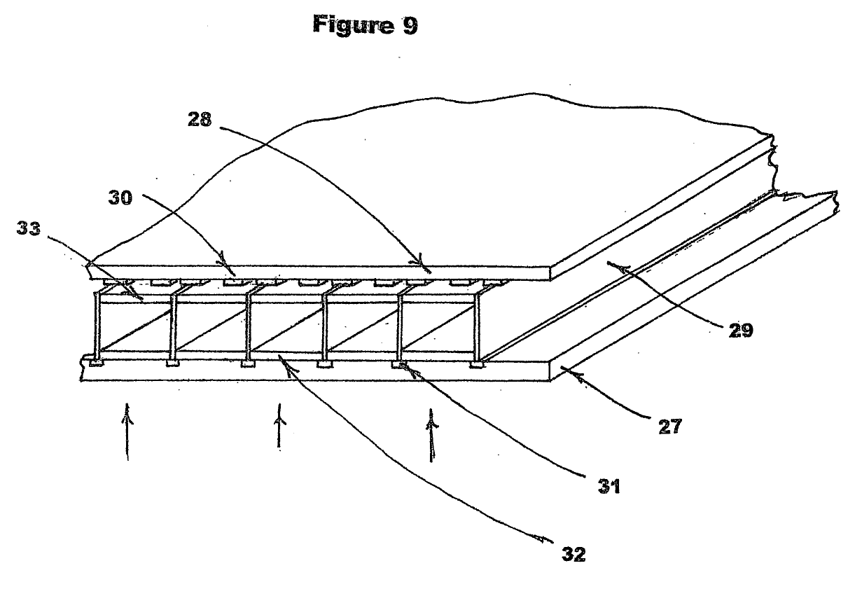

In the following description, the terms ‘proximal’ and ‘distal’ are used to assist in the description of the Figures considered. The pivotal turning points shown for FIGS. 9, 10 and 11 are not intended to be taken specifically as distal or proximal to the observer and may be either.

The invention provides not only the combination of spatial and temporal multiplexing, but also provides a design of temporal multiplexing stereoscopic conversion screen that can be used on its own. The design of the temporal multiplexing screen will now be described, and which can be used alone or when combined with the spatial multiplexing screen.

A macroscopic form of a dynamic light-tube stereoscopic conversion screen is shown in FIG. 9. The light-tube assembly is placed in front of the 2D-image between distal faceplate 27 and proximal faceplate 28 relative to the observer. The light-tubes are bounded by thin strips of conducting foil 29, which are pivoted along one edge 31 and free to move at the opposite edge. The pivoted edge is connected to an electrical voltage that alternates in phase with the temporally multiplexing monocular images corresponding to different monocular viewpoints. The free end moves near to transparent conducting strips 30 that run parallel along the free edge. Transparent spacers 32 and links 33 add mechanical stability to the assembly. For electrostatic movement of the foil strips 29, the voltage polarities of the foil strips 29 and the transparent conducting strips 30 are changed in sequence, as described below; by electrostatic attraction and repulsion the foil strips 29 deflect to the left and right, causing light to be directed to the appropriate monocular viewpoint. Similarly, for electromagnetic switching, the directions of electrical current though the foil strips 29 and transparent conducting strips 30 are changed in sequence; by electromagnetic attraction and repulsion the foil strips 29 deflect to the left and right.

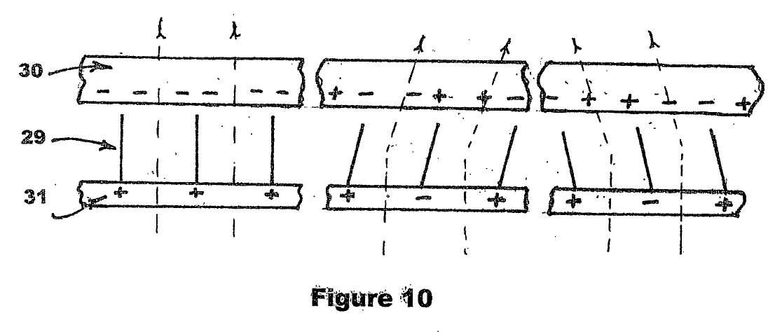

The electrical switching sequence for the electrostatic direction of the foil strips 29 will now be described with reference to FIG. 10. From left to right, three successive stages in the switching process are shown schematically as a greatly enlarged partial horizontal cross section. On the left, a negative voltage is applied to all transparent conducting strips 30 on the proximal faceplate and all foil strips 29 are charged positive by the polarity of the transparent conducting strips on the distal faceplate 31, to which they are electrically connected. As a result of electrostatic attraction, the foil strips 29 position themselves at right angles to the faceplates. Light from the image for a central monocular viewpoint will then be directed forwards to an observer.

In the central diagram, successive transparent conducting strips of the proximal faceplate 30 have alternate polarities while successive foil strips 29 also have alternate polarities corresponding to the voltages on the transparent conducting strips on the distal faceplate 31 to which they are electrically connected. As a result of electrostatic attraction and repulsion, the foil strips 29 position themselves such that light from the image for a right monocular viewpoint is directed to the right. Finally, if the sequence of polarities of the transparent conducting strips of the proximal faceplate 30 is reversed, the foil strips 29 position such that light from the image for a left monocular viewpoint is deflected to the left. For electromagnetic direction the same electrical switching sequence applies. In this embodiment, the positive signs of FIG. 10 are taken as showing the flow of an electrical current into the plane of the diagram and the negative signs as indicating the flow of an electrical current out of the plane of the paper along foil strips 29 and neighbouring transparent conducting strips 30 and 31.

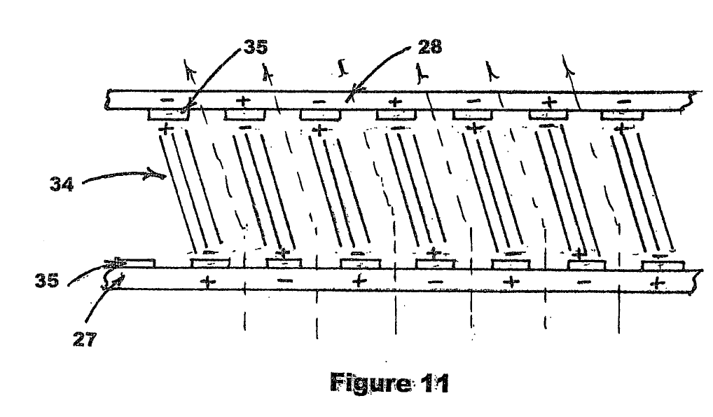

A possible problem with the macroscopic dynamic light-tube stereoscopic conversion screen described above is that the mass of the foil strips 29 may prevent sufficiently rapid movement in some applications. FIG. 11 shows microscopic light-tubes or light-tube boundaries 34 which would reduce such inertial, problems. Tie light-tubes or light-tube boundaries 34 may be magnetic or conductive fibres of suitably shaped cross section with the required optical properties. They may move in response to electrostatic forces due to changing voltages on the neighbouring transparent electrodes 35. Thus if a light-tube or light-tube boundary 34 is made of an electrical insulator and has one end near to, but not touching, a distal transparent conducting strip 35, an electrical charge of opposite polarity will be electro statically induced at that end. By further electrostatic induction, the original electrical polarity will appear at the far end of the light-tube or light-tube boundary. Due to electrostatic attraction or repulsion at the proximal end of the light-tube or light-tube boundary, the position of the light-tube or light-tube boundary can then be made to change by changing the polarity of the transparent electrodes on the proximal faceplate. FIG. 11 shows. the situation where alternate transparent electrodes of the distal faceplate have opposite polarities, leading to induced charges that cause the light-tubes or light-tube boundaries to position such that light from the image for a left monocular viewpoint is directed to the left. When the polarities of proximal and distal transparent conducting strips are reversed, the light-tubes or light-tube boundaries can be made to direct light from the image for a right monocular viewpoint to the right. By suitable choice of electrical polarities on distal and proximal transparent conducting strips the light-tubes or light-tube boundaries can be made to direct light from the image to a central monocular viewpoint directly ahead. Alternatively they may move in response to changing electromagnetic forces due to changing electrical currents through the neighbouring transparent conducting strips 35.

In this embodiment, positive signs of FIG. 10 can be construed as indicating the flow of an electrical current into the plane of the paper and the negative signs as indicating the flow of an electrical current out of the plane of the paper. The light-tubes or light-tube boundaries are made of a magnetically soft magnetic material such that they are temporarily magnetised by the electromagnetic field of the distal transparent conducting strips. This results in induced temporary magnetic poles being produced that interact with the electromagnetic field caused by current in the proximal transparent conducting strips. In this way electromagnetic attraction and repulsion occurs in the region of the proximal faceplate, causing the light-tubes or light-tube boundaries to position, directing light as required.

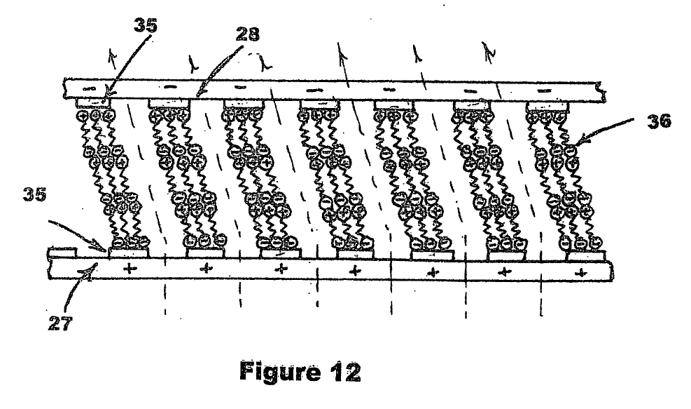

The dynamic light-tubes or light-tube boundaries could also be elongated molecules 36 or chains of molecules as shown in FIG. 12. In the following description, the term ‘molecules’ is used to mean both individual molecules and chains of molecules. Such molecules may have permanent or temporary electrostatic dipoles and would move in response to electrostatic forces due to changing voltages on the neighbouring transparent electrodes 35. Thus, if a molecule has a permanent electrical dipole with one end positively charged it can be made to take up one of three positions depending on the electrical polarities of transparent electrodes on proximal faceplate 28 and distal faceplate 27. In FIG. 11, the negative ends of molecules are attracted to positively charged distal transparent conducting strips while alternately, the positive ends of molecules are attracted to negative distal transparent conducting strips. At the proximal faceplate the other ends of each molecule, or chain of molecules are attracted to the opposite electrical polarity. As shown, the choice of polarities causes light to be directed from an image for a left monocular viewpoint to the left. When polarities on transparent conducting strips of either the proximal or distal faceplates are reversed, the molecules will position so as to direct light from an image for a right monocular viewpoint to the right. Under certain conditions of electrical polarity the molecules will position themselves such that light from the image to a central monocular viewpoint will be directed straight ahead.

Alternatively such molecules may have magnetic properties, for instance due to the inclusion of ferric components, and would move in response to changing electromagnetic forces due to changing electrical currents through the neighbouring transparent conducting strips 35.

In this case positive signs for the transparent conducting strips indicate flow of an electrical current into the plane of the paper, while negative signs indicate the flow of an electrical current out of the plane of the paper. The magnetic properties of the molecules cause them to change position dependent on the directions of currents in the transparent electrodes of the proximal and distal electrodes and thereby direct light as required.

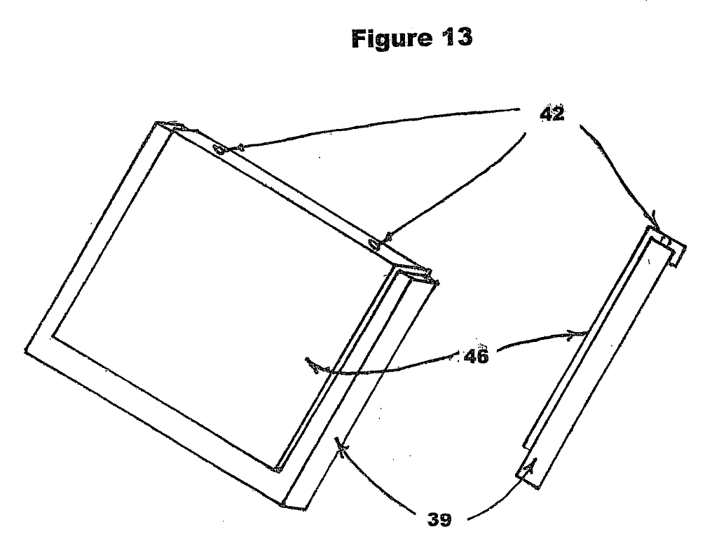

If so required by the user, any described stereoscopic conversion screen 2 may be taken away from the visual display unit when a stereoscopic effect is not required as shown in FIG. 13. The stereoscopic conversion screen assembly 46 rests or hooks over the top of the visual display unit bezel 39 and its height and angle are adjusted if necessary by means of screws 42.

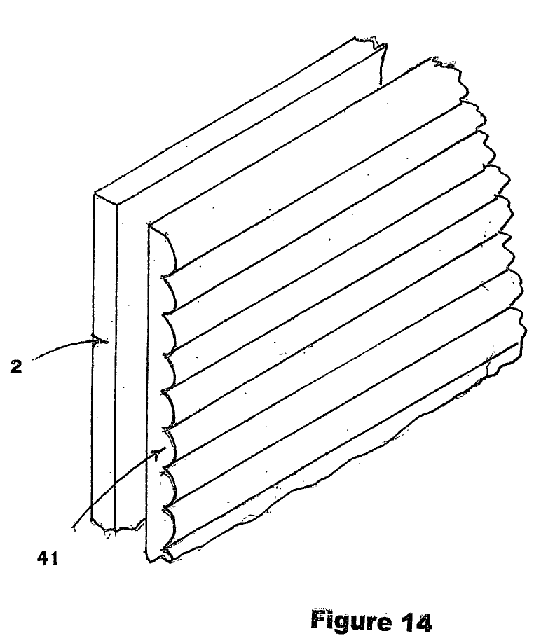

As shown in FIG. 14, to increase the vertical viewing angle by refraction a lens sheet 41 comprising an array of horizontal lenses, is placed in front of the stereoscopic conversion screen 2. Moving the lens sheet 41 a small distance perpendicularly away from the conversion screen 2 also causes multiple vertical picture elements or pixels to appear due to internal reflections, removing the effect of blank horizontal lines between the various multiplexed monocular images.

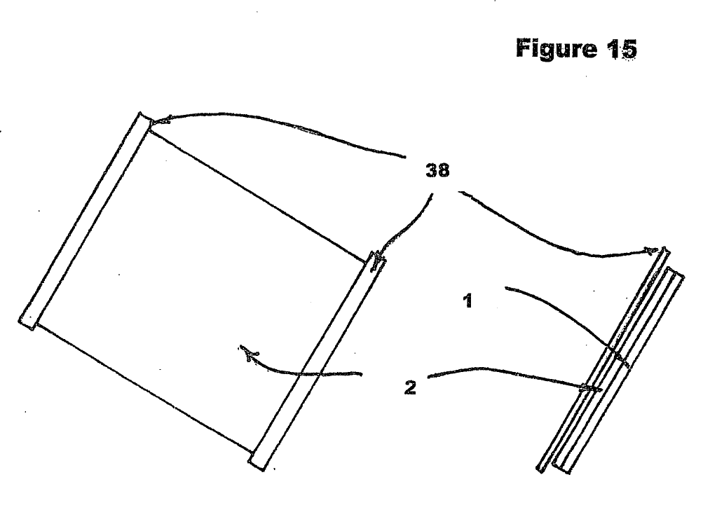

As shown in FIG. 15 to avoid loss of stereoscopic vision to the extreme left and right margins of the stereoscopic conversion screen 2, vertical opaque strips 38 may be placed a small distance in front of the left and right edges of the stereoscopic conversion screen 2. In this way, the extreme left and right 2D-image edges are obscured. This can also produce an enhanced perception of depth.

The invention provides spatially and/or temporally multiplexed images for conversion into a perceived 3D-display. The device of the invention offers minimal loss of 3D-display resolution, absence of lateral inversion and banding, low loss of brightness and reduced need for high visual display unit refresh rates when temporal multiplexing is used. Light-tubes direct light in appropriate directions to monocular viewpoints. For spatial multiplexing, the light-tubes may be present in pierced sheets, stacked strips, laminated grid designs or irradiated sheets. A multiple hole-piercing machine is described as well as an arrangement for producing light-tubes by irradiating radiation sensitive sheets. For temporal multiplexing, dynamic light-tubes or their boundaries are moved in phase with changes in monocular images, guiding light in the correct direction at the correct instant. If temporally and spatially stereoscopic conversion screens are combined, a multiplicative increase in the number of stereoscopic viewpoints is achieved.

A number of designs of spatially multiplexed screen have been described in detail. Other forms are possible, such as stacked transparent laminates each with a surface bearing a photographic, photo-etched or printed design, such that when these are stacked, light-tubes with the required directions are constructed..

Electro chromic materials may also be used to form a switch-able arrangement. When switched to a darkened state, multiple layers of such material can define the light guiding passageways, and when switched to a transparent state, the display can be used in normal 2D mode. With suitably patterned transparent electrodes of, for example SnO₂, on the front and back, the electro chromic material could be used both-to switch the 3D feature on and off and also to change the direction of the light-tubes.

If an electro-chromic material is used, the conversion screen may be laminated in order to minimise spreading of the electrical field and increase its strength for given a given voltage. Electro chromic effects as produced by nanocrystalline semiconductor films using phosphonated viologens can provide suitably fast reaction times, and adequate opacity. These can also be switched from light to dark or from dark to light, depending on the polarity of applied voltages.

In all examples above, the extreme left and right monocular viewpoints may be allowed to spread horizontally to the left or right respectively in order that viewing outside of the stereoscopic viewpoints still allows a perceived 2D display.

The laminated sheet and irradiation means for construction are particularly suitable for preparing such horizontally spread monocular viewpoints.

In the hole-punched embodiment, the sheet material for the conversion screen may be curved convex upwards during hole punching, with the maximum curvature parallel to the line of hole producing units. The screen upon being flattened for its normal viewing position will then cause light from all vertical regions of the screen to be directed to monocular viewpoints at the same horizontal level. This enables the full height of the screen to be seen without the necessity of a lens sheet as described elsewhere.

The generation of images for display will clearly need to take into account the design of the stereoscopic conversion arrangement. However, these image-processing techniques will be routine to those skilled in the art.

Various modifications will be apparent to those skilled in the art.

1-31. (canceled)

32. An stereoscopic display device, comprising:
a display device for displaying a pixellated display image; and
a stereoscopic conversion screen,
wherein the conversion screen comprises an array of light guiding members, each light guiding member being associated with an underlying pixel or sub-array of pixels, and wherein alternate rows of light guiding members are arranged to direct light from the associated pixel or sub-array of pixels to different viewing positions, wherein the device further comprises a temporal multiplexing screen for directing images to different viewing locations in time multiplexed manner.

33. A display device as claimed in claim 32, wherein the temporal multiplexing screen comprises an array of movable light guiding members.

34. A display device as claimed in claim 32, wherein the movable light guiding members are electro statically or electro magnetically controlled.

35. A display device as claimed claim 32, wherein the movable light guiding members have reflective or absorptive boundaries.

36. A display device as claimed in claim 35, wherein the movable light guiding members comprise microscopic fibres.

37. A display device as claimed in claim 35, wherein the movable light guiding members comprise molecules that have temporary or permanent dipoles.

38. A display device as claimed in claim 35, wherein the movable light guiding members comprise molecules that contain magnetic elements or groups.

39. An stereoscopic display device, comprising:
a display device for displaying a pixellated display image; and
a stereoscopic conversion screen,
wherein the conversion screen comprises an array of light guiding members, each light guiding member being associated with an underlying pixel or sub-array of pixels, and wherein alternate rows of light guiding members are arranged to direct light from the associated pixel or sub-array of pixels to different viewing positions, wherein the array of light guiding members are defined by a radiation sensitive sheet in which exposed light channels are defined.

40. A display device as claimed in claim 39, wherein the light guiding members comprise optical light-tubes.

41. A display device as claimed in claim 39, wherein the array of light guiding members comprises a stack of rows of light guiding members.

42. A display device as claimed in claim 41, wherein each row of light guiding members comprises an arrangement of walls of opaque material defining a plurality of channels which are each directed towards a common view point.

43. A display device as claimed in claim 39, wherein the array of light guiding members comprises a unitary screen formed from opaque material through which holes are formed at predetermined angles.

44. A display device as claimed in claim 39, wherein the array of light guiding members are defined by an electro chromic arrangement, which is switch-able between stereoscopic and 2D modes of operation.

45. A display device as claimed in claim 44, wherein the electro chromic arrangement comprises a plurality of electro chromic layers.

46. A display device as claimed in any preceding claim, further comprises a lenticular screen, comprising a array of lenses each extending in the row direction.

47. An stereoscopic display device, comprising:
a display device for displaying a pixellated display image; and
a stereoscopic conversion screen,
wherein the conversion screen comprises an array of light guiding members, each light guiding member being associated with an underlying pixel or sub-array of pixels, and wherein alternate rows of light guiding members are arranged to direct light from the associated pixel or sub-array of pixels to different viewing positions, wherein the device further comprises raised vertical edge strips that conceal the left and right vertical margins of the image.

48. A display device as claimed in claim 32, 33 or 47, wherein the stereoscopic conversion screen is manually removable from the display device.

49. A display device as claimed in claim 48, wherein the stereoscopic conversion screen comprises a position adjustment arrangement.

50. A method of generating an stereoscopic image, comprising:
generating a display image in which at least two sub-images are encoded into the complete image, with each sub-image being provided to a plurality of rows of pixels;
providing temporal multiplexing to direct images to different viewing locations in time-multiplexed manner;
displaying the complete time-multiplexed image;
using a stereoscopic conversion screen to direct the output of different rows of pixels corresponding to the different sub-images to different viewing positions.
